(19) United States
(12) Patent Application Publication
(10) Pub. No.: US 2012/0152362 A1
(43) Pub. Date: Jun. 21, 2012

(54) DEVICES AND METHODS FOR REDUCING OXYGEN INFILTRATION

(75) Inventors: Dennis W. Johnson, Simpsonville, SC (US); James H. Brown, Simpsonville, SC (US); Bo Oscarsson, Flat Rock, NC (US); Shane Jackson, Norris, TN (US)

(73) Assignee: FLUOR TECHNOLOGIES CORPORATION, Aliso Viejo, CA (US)

(21) Appl. No.: 13/324,846

(22) Filed: Dec. 13, 2011

Related U.S. Application Data
(60) Provisional application No. 61/424,220, filed on Dec. 17, 2010.

(51) Int. Cl. F17D 3/00; F16J 15/02; B23P 23/00

(52) U.S. Cl. 137/1; 29/401.1; 277/312

(57) ABSTRACT

Configurations and methods of reducing oxygen infiltration into an oxygen-sensitive process environment of a plant are presented in which carbon dioxide is isolated from a process stream within the plant, and in which a small portion of the isolated carbon dioxide is used in the plant as a transport gas or a seal gas for devices that are known to exhibit air in-leaking.

This application claims priority to our copending U.S. provisional application with the Ser. No. 61/424,220, which was filed Dec. 17, 2010.

### FIELD OF THE INVENTION

The field of the invention is methods and configurations to reduce oxygen infiltration into an oxygen sensitive environment, particularly as it relates to post-combustion carbon dioxide capture and capture of carbon dioxide during combustion of fuels using oxygen.

### BACKGROUND OF THE INVENTION

While significant progress has been made in various post combustion decarbonization processes and combustion processes using pure oxygen (oxy-fuel), several difficulties and drawbacks nevertheless remain. Most significantly, the above process often suffer from air leakage into the system, primarily around seals in devices such as fans and air heaters, which not only increases gas volume but also introduces nitrogen and oxygen into the gas stream. For post combustion carbon dioxide capture, the added oxygen can degrade the solvent faster. For oxy-fuel, the added oxygen and nitrogen introduce impurities in the product stream. As a consequence, additional processing and/or specialized equipment is required, which generally adds substantial expense to the processes. For example, while processing systems can often be designed to have sealed equipment to prevent air in-leaking at static interconnections of device components, it is in most instances impossible to keep air out of seals in rotating equipment. Thus, there is still a need for improved methods and devices in which air leakage into an oxygen sensitive environment is reduced.

### SUMMARY OF THE INVENTION

The inventive subject matter is directed to configurations and methods of reducing oxygen infiltration into an oxygen-sensitive process environment of a plant in which carbon dioxide is isolated by using a small portion of the isolated carbon dioxide as a seal gas for devices that are known to exhibit air in-leaking

In one especially preferred aspect, a method of reducing oxygen infiltration through a device into an oxygen-sensitive process environment of a plant will include a step of isolating carbon dioxide from a process stream within the plant and a further step of withdrawing a portion of the isolated carbon dioxide, which is them fed to the device as a seal gas. Thus, the device typically allows ingress of a gaseous fluid into the process environment, wherein at least part of the gaseous fluid is the portion of the isolated carbon dioxide.

In especially preferred aspects, the plant is a combustion plant, typically comprising a post-combustion decarbonization unit and/or an oxy-fuel combustion unit. In further contemplated aspects, the device will be a fan, a blower, an air heater, a damper, a sonic horn, a pulse system for a fabric filter, or a sootblower. Alternatively, or additionally, it should be appreciated that the isolated carbon dioxide can also be used as a transport medium for various items in the plant, and especially for a sorbent, a catalyst, activated carbon, ammonia, and/or a reagent for a chemical reaction. It is still further contemplated that where the device is not already outfitted for use with a seal gas, the device may be modified to allow feeding of the isolated carbon dioxide to the device. Regardless of the type and configuration of device, it is preferred that the isolated carbon dioxide forms at least part of the seal gas used in the device. Moreover, it should be noted that the isolated carbon dioxide may be compressed (or reduced in pressure) prior to feeding the isolated carbon dioxide into the device.

Therefore, and viewed from a different perspective, a method of modifying a device through which oxygen infiltration into an oxygen-sensitive process environment (e.g., post-combustion decarbonization unit or oxy-fuel combustion unit) of a plant occurs will preferably include a step of fluidly coupling a source of isolated carbon dioxide to the device such that isolated carbon dioxide from the source can pass through the device into the oxygen-sensitive process environment. In another step, carbon dioxide is separated from a process stream in the plant to thereby produce the isolated carbon dioxide, which is then fed to the device.

In most typical embodiments, the device (e.g., fan, blower, air heater, damper, sonic horn, pulse system for a fabric filter, sootblower, etc.) comprises a seal gas box that is fluidly coupled to the source of isolated carbon dioxide. As appropriate, the isolated carbon dioxide may be compressed (or reduced in pressure) prior to feeding the isolated carbon dioxide to the device. Most typically, the compressed isolated carbon dioxide will have a pressure of between 20 psia and 200 psia.

In another aspect of the inventive subject matter, a method of processing isolated carbon dioxide includes a step of isolating carbon dioxide from an exhaust stream of an oxy-fuel combustion unit or from a regenerator of a post-combustion decarbonization unit, and another step of compressing the isolated carbon dioxide and splitting the compressed isolated carbon dioxide into a sequestration or product stream and a side stream. In yet another step, the side stream is used as a seal gas for a device (e.g., fan, blower, air heater, damper, sonic horn, pulse system for a fabric filter, sootblower, etc.) that operates in an oxygen-sensitive process environment of the oxy-fuel combustion unit or post-combustion decarbonization unit.

Most typically, the isolated carbon dioxide has a purity of at least 90 mol %, and/or the side stream has a pressure of between 20 psia and 200 psia. Where desired, at least a portion of the carbon dioxide of the side stream can be temporarily in a tank prior to use as a seal gas.

Various objects, features, aspects and advantages of the inventive subject matter will become more apparent from the following detailed description of preferred embodiments.

### DETAILED DESCRIPTION

The inventive subject matter provides devices, systems, and methods in which carbon dioxide is used as a seal gas, transport gas, and/or compressed gas in one or more processes that are associated with the generation and/or capture of carbon dioxide (e.g., oxygen fired furnaces, post-combustion decarbonization, etc.). Most typically, a small fraction of captured carbon dioxide is used as a seal gas for fans and various other equipment that would otherwise allow for leak air to enter into the flue gas stream. Among other advantages, it should be particularly appreciated that the carbon dioxide is already available at the plant and that the carbon dioxide is an inert gas (with respect to process conditions in such plants).

Thus, it should be recognized that carbon dioxide isolated by post-combustion carbon dioxide capture can be used to prevent continuous air infiltration (e.g., at seals and bearings of rotating equipment like fans, or moving equipment like dampers, etc.). Additionally, it is contemplated that the carbon dioxide isolated from the capture process may be employed as replacement for process air that is otherwise continuously or intermittently introduced into flue gases or other process fluids. For example, carbon dioxide may be used as a conveying medium to minimize the amount of oxygen added to flue gases where reagents (e.g., reagents to bind or react with sulfurous species, activated charcoal, etc.) are added to the flue gases.

For example, where it is desired to reduce oxygen infiltration through a device into an oxygen-sensitive process environment of a plant, the inventors contemplate that where the plant generates carbon dioxide from a process stream (e.g., combustion exhaust, gasification product, and especially syngas, catalyst regenerator effluent, coker offgas, etc.), at least a portion of the so produced carbon dioxide can be withdrawn as a side stream from the point of production, a point of further purification, and/or from a compressor or pressure reduction device. Most typically, the amount of the withdrawn carbon dioxide will be relatively minor as compare to the remaining carbon dioxide that is generated in/provided by the process stream. For example, in most typical applications, the ratio of generated carbon dioxide to withdrawn carbon dioxide is typically at least 10:1, more typically at least 100:1, and most typically at least 1000:1. Of course, it should be appreciated that the carbon dioxide need not necessarily be used right away, but may be temporarily stored in gaseous or liquid form.

Regardless of the manner of withdrawal and/or storage, it is contemplated that the carbon dioxide is fed to a device that is a known source for oxygen and/or nitrogen ingress to the oxygen-sensitive process environment. Such oxygen and/or nitrogen ingress is in some cases due to in-leakage of ambient air around a rotating element of the device. In other cases, oxygen and/or nitrogen ingress is due to use of ambient air as a transport or actuation medium. For example, and among other known devices, known sources for oxygen and/or nitrogen ingress includes fans, blowers, air heaters, dampers, sonic horns, pulse systems for a fabric filter, sootblower. Additionally, it should be noted that various connectors may also present a source of oxygen and/or nitrogen ingress due to less than desirable tightness of the connection. Such ingress is especially problematic where the oxygen-sensitive process environment has a pressure that is lower than ambient pressure or provides for a venture effect at the device. Thus, it should be noted that the devices will have at east one pathway that allows ingress of a gaseous fluid into the process environment. Using the isolated carbon dioxide at the device will advantageously allow to reduce or even entirely eliminate oxygen and/or nitrogen ingress into the oxygen- (or nitrogen-) sensitive process environment.

Therefore, it should be noted that where contemplated devices already include a seal gas box or other mechanism to provide a seal gas to the device, the seal gas box or other mechanism may be fluidly coupled to a source of the carbon dioxide (e.g., CO2 compressor, regenerator, flash vessel, autorefrigeration unit, etc.). Alternatively, contemplated devices may also be retrofitted with a seal gas box or other mechanism to provide the carbon dioxide as a seal gas to the retrofitted device. regardless of the manner of providing the carbon dioxide to the device, it is contemplated that previously isolated carbon dioxide is then provided to the device such that the carbon dioxide will pass through the device into the oxygen- (or nitrogen-) sensitive environment. As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Of course, it should be recognized that the manner of carbon dioxide capture is not critical to the inventive subject matter, and it should be recognized that all known manners are deemed suitable for use in conjunction with the teachings presented herein. For example suitable manners of carbon dioxide capture include Fluor's Econamine FG+ system and other solvent based systems using physical and/or chemical solvents, various membrane separation processes, and pressure swing absorption processes. Still further, it should be noted that the carbon dioxide may be provided or stored as a refrigerated liquid (e.g., where the carbon dioxide is isolated via autorefrigeration processes). Similarly, it is noted that the carbon dioxide need not be ultra-pure carbon dioxide, but that the carbon dioxide may include other non-oxygen components. For example, suitable carbon dioxide purity is preferably between 70-90 mol % purity, and more preferably above 90 mol %. While not preferred, it is also contemplated that the carbon dioxide may include other acid gases, water, or noble gases. Most typically, the pressure of the carbon dioxide used will depend on the particular environment and/or device, but is generally preferred that the pressure is between 2 psia and 200 psia, and more typically between 10 psia and 50 psia.

In cases where the carbon dioxide is already compressed by multi-stage compressors as is often found in decarbonization systems (or is derived from high- or medium-pressure flash vessels), additional compressors can be eliminated for all applications using carbon dioxide as the seal or process gas, and the carbon dioxide can be piped to the end use as a transport medium, pulse medium or seal medium at the conditions appropriate for the use. Generally, this would be less than 100 psi, as opposed to greater that 2,200 psi required to transport the carbon dioxide from the site as a supercritical fluid. The carbon dioxide could be piped to the end use as a high pressure liquid though it is generally simpler to use it as a gas. Appropriate equipment and means such as control valves, pressure control devices, etc. would be used to meet the needs of the end use whether the carbon dioxide is piped as a liquid or a gas. Where the pressure of the already compressed carbon dioxide exceeds the pressure of the carbon dioxide at the point of use, suitable pressure reduction devices are expressly contemplated.

For example, previously captured carbon dioxide is used as seal air to prevent air from in-leaking in a flue gas treatment plant. In general, these systems operate under a negative pressure and air will frequently leak into the process equipment. To prevent in-leaking, carbon dioxide is used to replace air as a medium for cooling bearings and seals and/or for conveying of various chemicals delivered to the flue gas (e.g., for removal of halides or acid gases such as SO₂ or SO₃). For example, the shaft such as on fans or other rotating devices used for processes that involve combustion of fossil fuels for which carbon dioxide recovery is anticipated, are allowed to leak. Since the process is operated under slight vacuum, carbon dioxide is used as the medium that is allowed to leak past the seal and into the flue gases, thereby preventing addition of oxygen containing air. In such cases, a small quantity of the previously isolated carbon dioxide may be fed to a special chamber or “seal box” at the appropriate conditions in which the carbon dioxide provides the seal gas and cooling required by the equipment (e.g., fan, blower, air heater, or damper). In such systems and methods, it should therefore be appreciated that at least a portion of the added carbon dioxide can be recycled through the process and does not produce an additional undesired contaminant. Additionally, it is also contemplated that the carbon dioxide can be used as a pulse medium for fabric filters, as a transport and dilution medium for ammonia to a selective catalytic reduction (SCR) and selective non-catalytic (SNCR) NOx reduction system, as a transport medium for activated carbon and other sorbents used to control mercury and acid gases, and/or as a transport medium for ash conveying. Therefore, and viewed more generally, it should be appreciated that previously isolated carbon dioxide is used as a sole or partial replacement for air in any application or system that would otherwise allow air ingress into the flue gas stream.

Consequently, and depending on the source and/or use for the isolated carbon dioxide, it should be appreciated that the purity of the carbon dioxide may vary considerably and that the purity may be as low as 50 mol % (and even less). However, it is generally preferred that the purity of the carbon dioxide will be at least 70 mol %, more typically at least 80 mol %, and most typically at least 90 mol %. With respect to the remaining carbon dioxide it is noted that all known manners of use are contemplated herein, and especially include sequestration, liquefaction, sale, and storage.

Therefore, and viewed from a different perspective, the inventors also contemplate that a stream of isolated carbon dioxide can be processed by compression and splitting the compressed carbon dioxide stream into a sequestration or product stream and a side stream that is then used as a seal gas in a device that is operated in an oxygen-sensitive process environment of an oxy-fuel combustion unit or a post-combustion decarbonization unit.

In still further suitable examples, the previously isolated carbon dioxide may also be used in sonic horns and/or sootblowers for cleaning combustion chambers and associated equipment in a manner that reduces or eliminates introduction of oxygen into the combustion equipment. It should be noted that even though carbon dioxide is added to the process, processing conditions are simplified or improved by reducing or elimination of undesirable components (e.g., N₂, O₂, H₂O, Ar, trace gases, etc.). Such advantages are particularly desirable for oxy-fuel applications as inert replacement with carbon dioxide simplifies compression and final gas separation. Similarly, in post combustion carbon dioxide capture, air replacement with carbon dioxide reduces the oxygen content of the flue gas stream, which reduces potential solvent loss due to solvent oxidation.

Additionally, it should also be appreciated that contemplated systems and methods will include modification and/or replacement of equipment to reduce air infiltration. For example, a regenerative air heater would be replaced with a non-leaking type, seals would be tightened to reduce leakage, etc. While such mitigation efforts are generally known, they have not been implemented in the above applications due to added costs. However, in the above applications reduction of air and oxygen infiltration by modification and/or replacement of equipment is thought to outweigh the added cost by the advantage of less air and oxygen in the gas stream to the carbon dioxide capture system.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of reducing oxygen infiltration through a device into an oxygen-sensitive process environment of a plant, comprising:
isolating carbon dioxide from a process stream within the plant;
withdrawing a portion of the isolated carbon dioxide, and feeding the portion of the isolated carbon dioxide to the device;
wherein the device is configured to allow ingress of a gaseous fluid into the process environment; and
wherein the portion of the isolated carbon dioxide is at least part of the gaseous fluid.

2. The method of claim 1 wherein the plant is a combustion plant.

3. The method of claim 2 wherein the process environment comprises a post-combustion decarbonization unit.

4. The method of claim 2 wherein the process environment comprises an oxy-fuel combustion unit.

5. The method of claim 1 wherein the device is selected from the group consisting of a fan, a blower, an air heater, a damper, a sonic horn, a pulse system for a fabric filter, and a sootblower.

6. The method of claim 1 wherein isolated carbon dioxide is used as a transport medium for a component selected from a group consisting of a sorbent, a catalyst, activated carbon, ammonia, and a reagent for a chemical reaction.

7. The method of claim 1 wherein the device is modified to allow the feeding of the portion of the isolated carbon dioxide to the device.

8. The method of claim 1 wherein the device uses a seal gas, and wherein at least part of the seal gas is the portion of the isolated carbon dioxide.

9. The method of claim 1 further comprising a step of compressing the portion of the isolated carbon dioxide prior to the step of feeding the portion of the isolated carbon dioxide to the device.

10. A method of modifying a device through which oxygen infiltration into an oxygen-sensitive process environment of a plant occurs, comprising:
fluidly coupling a source of isolated carbon dioxide to the device such that isolated carbon dioxide from the source can pass through the device into the oxygen-sensitive process environment;
separating carbon dioxide from a process stream in the plant to thereby produce the isolated carbon dioxide; and
feeding the isolated carbon dioxide to the device.

11. The method of claim 10 wherein the device comprises a seal gas box, and wherein the step of fluidly coupling the source of isolated carbon dioxide to the device comprises fluidly coupling the source of isolated carbon dioxide to the seal gas box.

12. The method of claim 10 wherein the device is selected from the group consisting of a fan, a blower, an air heater, a damper, a sonic horn, a pulse system for a fabric filter, and a sootblower.

13. The method of claim 10 further comprising a step of compressing the isolated carbon dioxide prior to the step of feeding the isolated carbon dioxide to the device.

14. The method of claim 13 wherein the step of compressing is compressing the isolated carbon dioxide to a pressure of between 20 psia and 200 psia.

15. The method of claim 10 wherein the oxygen-sensitive process environment is a post-combustion decarbonization unit or an oxy-fuel combustion unit.

16. A method of processing isolated carbon dioxide, comprising:
isolating carbon dioxide from an exhaust stream of an oxy-fuel combustion unit or from a regenerator of a post-combustion decarbonization unit;
compressing the isolated carbon dioxide and splitting the compressed isolated carbon dioxide into a sequestration or product stream and a side stream; and
using the side stream as a seal gas in a device that operates in an oxygen-sensitive process environment of the oxy-fuel combustion unit or post-combustion decarbonization unit.

17. The method of claim 16 wherein isolated carbon dioxide has a purity of at least 90 mol %.

18. The method of claim 16 wherein the side stream has a pressure of between 20 psia and 200 psia.

19. The method of claim 16 wherein the device is selected from the group consisting of a fan, a blower, an air heater, a damper, a sonic horn, a pulse system for a fabric filter, and a sootblower.

20. The method of claim 16 further comprising a step of storing at least a portion of the carbon dioxide of the side stream in a tank prior to the step of using the side stream.
